(19) United States
(12) Patent Application Publication
(10) Pub. No.: US 2006/0274654 A1
(43) Pub. Date: Dec. 7, 2006

(54) Range matching

(75) Inventor: Udaya Shankara, Bangalore (IN)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/144,293

(22) Filed: Jun. 3, 2005

(51) Int. Cl. H04L 12/26; H04L 12/43

(52) U.S. Cl. 370/230; 370/458

(57) ABSTRACT

In one embodiment, a method comprises receiving, in a network node, a control packet, determining, from data in the control packet, a time slot range request, encoding the time slot range request into a search data set comprising one or more elements expressed in ternary form, and searching an addressable memory module using one or more of the elements in the search data set as a search key.

### BACKGROUND

Communication networks route data packets from a source to a destination using one or more networking protocols such as, e.g., the internet protocol (IP). In a high-speed communication networks such as, e.g., optical burst switched (OBS) networks, data packets are assembled into bursts at an ingress router. Data bursts are routed through the OBS network and are disassembled into packets again at an egress router.

OBS networks implement a reservation system that allocates bandwidth for data bursts traversing the network. An OBS data burst includes two portions: a Burst Control Packet (BCP) and a data burst. The BCP is transmitted first to reserve bandwidth for the data burst, and the data burst is transmitted after an offset time interval. Each network node processes the BCP and allocates a wavelength and one or more time slots for the optical data burst associated with the BCP.

The BCP typically undergoes optical to electronic (O/E) and electronic to optical (E/O) conversion at each network node. The time required to perform electronic processing of BCPs can represent a bottleneck in an OBS network.

### BRIEF DESCRIPTION OF THE DRAWINGS

The detailed description is provided with reference to the accompanying figures.

FIG. 1 is a schematic illustration of a system employing a network processor in accordance with an embodiment.

FIG. 2 is a schematic illustration of a network processor in accordance with an embodiment.

FIG. 3 is a schematic illustration of timeslot allocation in a network processor in accordance with an embodiment.

FIG. 4 is a flowchart illustrating operations in an example method for efficient range matching in accordance with an embodiment.

FIG. 5 is a schematic illustration of an example context for the operations depicted in FIG. 4 in accordance with an embodiment.

FIG. 6 is a schematic illustration of a truth table in accordance with an embodiment.

### DETAILED DESCRIPTION

Described herein are exemplary systems and methods for range matching that may be implemented in a communication network node. In the following description, numerous specific details are set forth in order to provide a thorough understanding of various embodiments. However, it will be understood that the various embodiments may be practiced without the specific details. In other instances, well-known methods, procedures, components, and circuits have not been described in detail so as not to obscure the particular embodiments.

The methods described herein may be embodied as logic instructions on a computer-readable medium. When executed on a processor such as, e.g., a network processor, the logic instructions cause a processor to be programmed as a special-purpose machine that implements the described methods. The processor, when configured by the logic instructions to execute the methods described herein, constitutes structure for performing the described methods.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

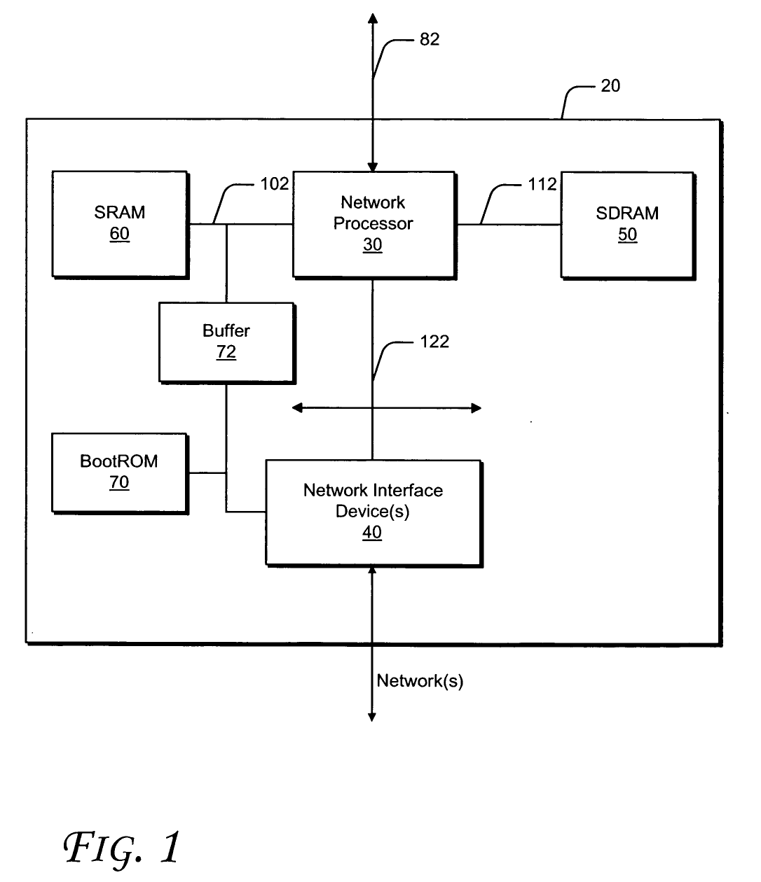

FIG. 1 is a schematic illustration of a system 20, employing a network processor 30 in accordance with an embodiment. System 20 may be embodied as, e.g., a router, gateway, firewall, switch, bridge, line card, or traffic aggregation point, depending on its programming and the type(s) of network interface device(s) 40 that it connects.

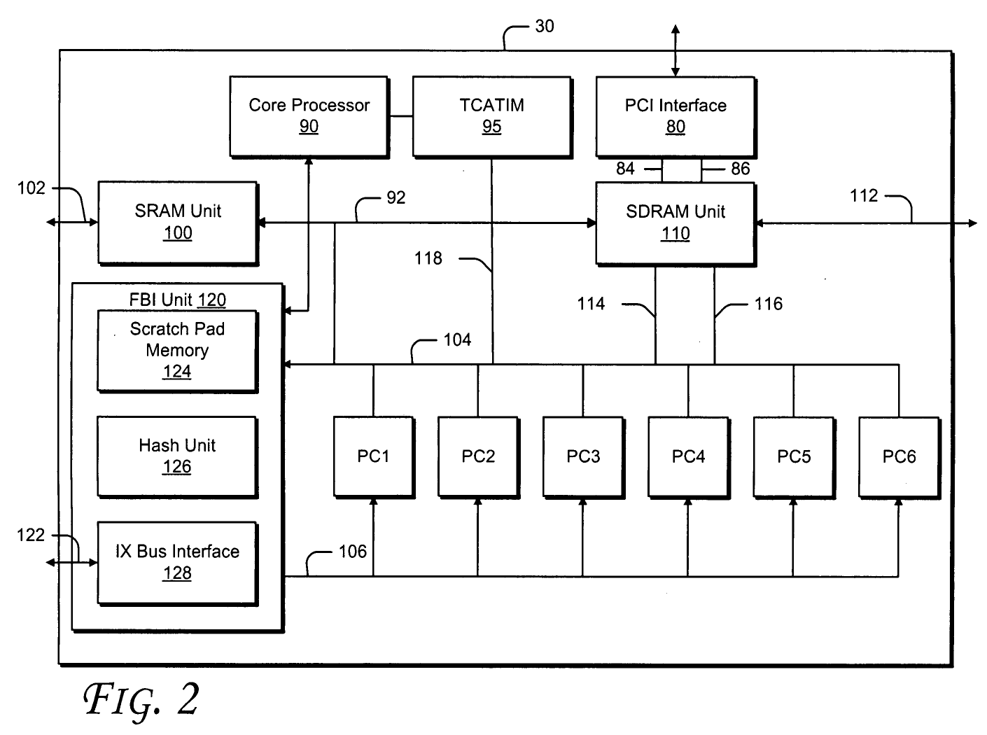

System 20 includes network processor 30. In one embodiment network processor 30 may be embodied as, e.g., an Intel® IXP1200-series or IXP2400-series network processor, manufactured by Intel Corporation, although the subject matter described herein may be readily adaptable to network processors offered by other manufacturers. The internal structure of one example network processor 30 will be described in conjunction with the presentation of FIG. 2.

Network processor 30 communicates with other system components over a number of buses: a 32-bit-wide PCI (Peripheral Component Interconnect) bus 82; a 32-bit-wide (data) SRAM (Static Random Access Memory) bus 102; a 64-bit-wide (data) SDRAM (Synchronous Dynamic Random-Access Memory) bus 112; and a 64-bit-wide reconfigurable “IX” Bus 122 supporting media connections. PCI bus 82 may be used, for example, to couple network processor 30 to a system host processor and/or PCI peripherals (not shown). SRAM bus 102 couples network processor 30 to an SRAM 60, which is used, for example, to store lookup tables and other information needed during packet processing. A buffer 72 also couples SRAM bus 102 to a bootROM 70, used to initialize system 20, and to a control port on network interface device(s) 40. SDRAM bus 112 couples network processor 30 to an SDRAM 50, which may be used, for example, to store packets/cells during processing and forwarding tables. IX bus 122 couples network processor 30 to one or more network interface device(s) 40, and can also be used to couple a second network processor (not shown) to the system. The network interface device(s) 40 provide an interface with one or more communication networks such as, e.g., a high-speed data communication network.

FIG. 2 is a schematic illustration of network processor 30 in accordance with an embodiment. FIG. 2 is representative of an Intel® IXP12xx network processor, manufactured by Intel Corporation. A core processor 90 provides traditional microprocessor operations. Six programmable cores PC1 to PC6 process packets transceived by network processor 30. An SRAM unit 100, an SDRAM unit 110, and a FBI (Fast Bus Interface) unit 120 provide external interface services respectively to SRAM bus 102, SDRAM bus 112, and IX bus 122. A PCI interface 80 provides PCI connectivity for network processor 30.

A plurality of 32-bit data buses couple the blocks of network processor 30. Core processor 90 couples to PCI interface 80, SRAM unit 100, SDRAM unit, 110 and FBI unit 120 through a data bus 92. Data buses 104 and 106 couple the programmable cores (PC1 through PC6) to SRAM unit 100 and FBI unit 120. Data buses 114 and 116 couple the programmable cores to SDRAM unit 110. Data buses 84 and 86 couple PCI interface 80 directly to SDRAM unit 110. Data bus 118 couples the programmable cores PC1-PC6 to the TCATIM 95.

SRAM unit 100 and SDRAM unit 110 queue and arbitrate memory access requests generated by core processor 90, the programmable cores PC1-PC6, and PCI interface 80 (SDRAM unit 110 only). SRAM unit 100 and SDRAM unit 110 can process burst requests for up to eight consecutive 32-bit words.

FBI unit 120 comprises an on-chip scratchpad memory 124, a hash unit 126 to generate hash keys, and an IX bus interface 128. IX Bus interface 128 includes receivers and drivers and receives and transmits FIFO registers for IX bus 122.

In one embodiment network processor 30 further comprises a content addressable memory. In one embodiment the content addressable memory may be implemented as a multi-bank ternary content addressable ternary input memory (TCATIM) 95, however other addressable memory may be used. TCATIM 95 is similar to a ternary content addressable memory, but is configured to accept ternary inputs as search keys. In alternate embodiments TCATIM 95 may be embodied in a separate chip in communication with network processor 30.

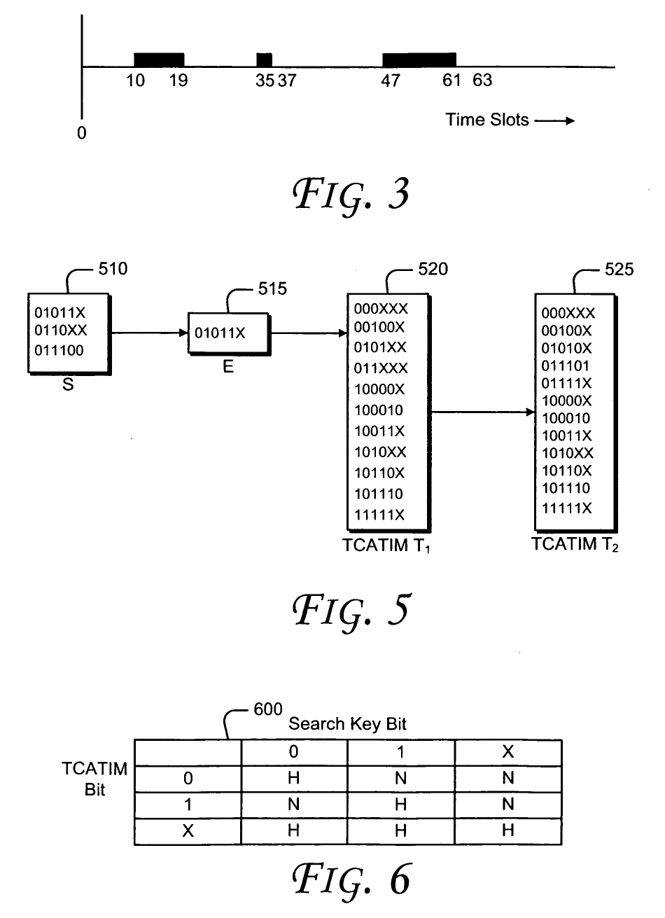

In an OBS network processor 30 receives a BCP packet and reserves one or more time slots for the data packet(s) associated with the BCP. FIG. 3 is a schematic illustration of one example of time slot allocation in a network processor. Referring to FIG. 3, a time slot allocation scheme in which time slots are allocated in a 64 time slot window (0-63) is represented on the X axis. Timeslots 10-19, 35-37, and 47-61 have been allocated to previous data bursts. Hence, time slots 0-9, 20-34, 38-46 and 62-63 are currently available for allocation to a data burst. When processing a BCP, network processor 30 evaluates the available time slots to determine whether sufficient time slots are available to transmit the data packets associated with the BCP, a technique referred to as range matching.

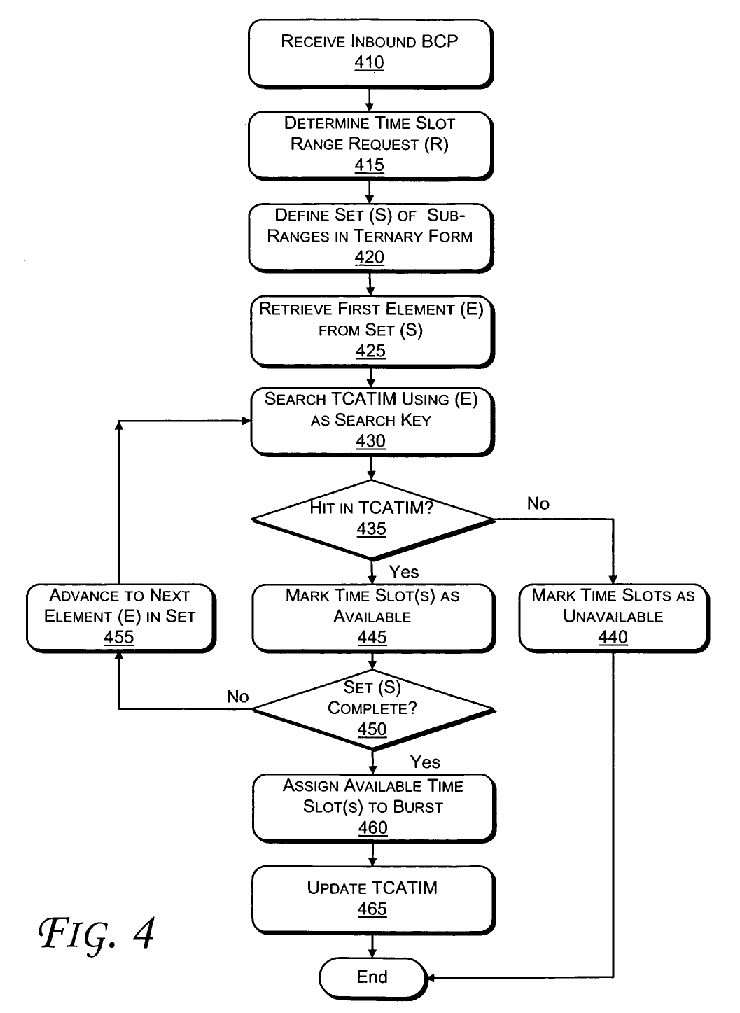

In one embodiment, TCATIM 95 stores indicia of the available time slots and network processor 30 uses a ternary search key scheme to facilitate efficient range matching. FIG. 4 is a flowchart illustrating operations in an example method for efficient range matching. Referring to FIG. 4, at operation 410 an inbound BCP is received, e.g., at a network processor in an OBS network.

At operation 415, the network processor (or an adjunct processor) determines a time slot range request for the data burst associated with the received BCP. In one embodiment the inbound BCP may include a request for a specific time slot range. In an alternate embodiment, the network processor 30 (or an adjunct processor) may make this determination by comparing the bandwidth in the time slots available for allocation against the bandwidth necessary to transmit the data burst associated with the received BCP. This comparison determines a number of time slots required to transmit the data burst associated with the received BCP, and the network processor 30 (or an adjunct processor) may generate a time slot range request based on this number.

At operation 420, the network processor 30 (or an adjunct processor) defines a set (S) of subranges from the time slots requested by the BCP. In one embodiment the set of subranges are represented in a ternary form. The network processor 30 (or an adjunct processor) determines whether the requested range of time slots is available to be allocated to the data burst.

FIG. 5 is a schematic illustration of an example context for the operations depicted in FIG. 4. Referring briefly to FIG. 3, assume that the incoming BCP results in a request for time slots 22-28 to transfer the data burst associated with the BCP. Referring to FIG. 5, a set (S) 510 of sub-ranges representing the requested time slots is defined. In one embodiment the length of each sub-range is a power of 2, and the sub-ranges are represented in ternary form. Hence, the set (S) 510 depicted in FIG. 5 includes the ternary representation of slots 22-23 (01011X), 24-27 (0110XX), and 28 (011100). The set (S) 510 may be stored in a suitable memory locations such as, e.g., a volatile memory module associated with the network processor (or adjunct processor).

At operation 425 the first element (E) is retrieved from the set (S) of sub-ranges generated in operation 420, and at operation 430 the TCATIM is searched using the first element (E) from the set (S) as a search key. As described above, the TCATIM includes entries representing, in ternary form, the time slots available for allocation. In the embodiment depicted in FIG. 5, the first element (E) is indicated as reference numeral 515.

In one embodiment, the TCATIM executes a search operation that performs a bitwise matching operation of each bit in the search key bit against the corresponding bit for each entry in the TCATIM. FIG. 6 is a schematic illustration of a truth table 600 to determine whether a search of TCATIM 520 with a ternary search key results in a hit. The letter H indicates a match, while the letter N indicates no match. In one embodiment the bitwise matching operation may be performed in parallel, such that the first bit of the search key is matched against the first bit of each entry in the TCATIM contemporaneously, then the second bit of the search key is matched against the second bit of each entry in the TCATIM contemporaneously, and so on. In alternate embodiments, the bitwise matching operation is performed serially, such that the search key is matched against the first entry in the TCATIM, then the second, then the third, etc.

Referring to FIG. 4, at operation 435 it is determined whether a search key generates a hit against an entry in the TCATIM. In one embodiment, if during the bitwise matching operation, there are hits for all the bits of an entry, then the entry is treated as a hit with respect to the search key (this is referred to as the TCATIM Hit). If, at operation 435, the search does not result in a hit in the TCATIM, then control passes to operation 440 and the time slots represented in the set (S) 510 are marked as unavailable to satisfy the slot request resulting from the BCP, and the operations of FIG. 4 then terminate. In response to such termination, the network processor (or an adjunct processor) may take one or more remedial actions. For example, the network processor (or an adjunct processor) may generate an error message indicating that the requested time slot allocation was unavailable. Alternatively, the network processor (or an adjunct processor) may initiate a new time slot range request, effectively restarting the operations of FIG. 4 at operation 415, but operating on a different range of time slots. By contrast, the search with the first element (E) 515 results in a hit in the TCATIM, then control passes to operation 445 and the time slots are marked as available for allocation.

Referring back to FIG. 4, if at operation 450 the search of set (S) is not complete, then control passes to operation 455 and the next element in the search set (S) 510 is used as the search key. Hence, in the example depicted in FIG. 5, the TCATIM is searched using the ternary element 0110XX as a search key.

The operations 430-455 are repeated in a loop until either the search fails to result in a hit at operation 435 or until the set (S) is complete at operation 450, in which case control passes to operation 460 and the available time slots are assigned to the data burst associated with the BCP.

At operation 465, the TCATIM is updated to reflect the allocation of the memory slots to the data burst associated with the BCP. Referring to FIG. 5, the TCATIM 520 represents the TCATIM at time T₁, which is updated to reflect the allocation of slots 22-28 at time T₂, as represented by TCATIM 525.

The operations of FIG. 4 may be repeated for each BCP received for processing by the network node. Encoding the search range into ternary form for use as search key(s) in the TCATIM 95 enables range matching searches to be performed in logarithmic complexity, rather than in linear complexity, which increases the efficiency of range matching operations.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
receiving, in a network node, a control packet;
determining, from data in the control packet, a time slot range request;
encoding the time slot range request into a search data set comprising one or more elements expressed in ternary form; and
searching an addressable memory module using one or more of the elements in the search data set as a search key.

2. The method of claim 1, wherein receiving, in a network node, a control packet comprises receiving a burst control packet in a network processor.

3. The method of claim 1, wherein determining, from data in the control packet, a time slot range request comprises retrieving a time slot range request from data in the control packet.

4. The method of claim 1, wherein determining, from data in the control packet, a time slot range request comprises:
determining a bandwidth allocation for a data burst associated with the burst control packet; and
determining a number of time slots required to satisfy the bandwidth allocation.

5. The method of claim 1, further comprising marking as available one or more time slots in the addressable memory module that match a search key.

6. The method of claim 5, further comprising assigning one or more available time slots to a data burst associated with the control packet.

7. The method of claim 6, further comprising updating the addressable memory module to remove one indicia of assigned time slots.

8. A method, comprising:
obtaining, in a processor, a ternary search key; and
applying the ternary search key to the contents of an addressable memory module associated with the processor.

9. The method of claim 8, wherein the processor comprises multiple programmable cores integrated on a single die.

10. The method of claim 8, wherein obtaining, in a processor, a ternary search key comprises:
defining a set of ternary search keys from information in a control packet received by the processor; and
selecting one of the ternary search keys from the set of ternary search keys.

11. The method of claim 8, further comprising:
marking an element in the addressable memory module with an indicia of a hit when applying the ternary search key to the element of a addressable memory module generates a hit.

12. The method of claim 8, further comprising:
marking an element in the addressable memory module with an indicia of a miss when applying the ternary search key to the element of a addressable memory module generates a miss.

13. An apparatus comprising a processor to:
obtain one or more timeslot range requests from information in a control packet;
convert the one or more timeslot range requests into one or more ternary search keys;
search a addressable memory module for one or more elements corresponding to the one or more ternary search keys;
mark an element of the addressable memory module with an indicia indicating a hit when the element in the addressable memory module corresponds to one of the search keys.

14. The apparatus of claim 13, further comprising a network interface to receive a control packet from a communication network.

15. The apparatus of claim 13, further comprising:
a processor to generate a list of one or more elements marked with an indicia indicating a hit; and
a network interface to transmit one or elements from the list to a receiving node via a communication network.

16. The apparatus of claim 13, further comprising a processor to update the addressable memory module.

17. A network forwarding device, comprising:
a network interface to receive a control packet including information that identifies a range of time slots to transfer a data burst associated with the control packet;
a processor coupled to the network interface to:
search an addressable memory module using a ternary search key derived from the range of time slots to determine whether one or available time slots corresponds to the search key;
assign an available time slot to the data burst associated with the control packet; and
a crossbar switch to transmit the data burst associated with the control packet.

18. The network forwarding device of claim 17, further comprising a processor to transmit, via the network interface, indicia of one or more available time slots in the addressable memory module.

19. The network forwarding device of claim 17, further comprising a processor to update the addressable memory module to indicate time slots assigned to the data burst associated with the data.

20. A method to allocate time slots to data bursts in a communication network, comprising:
receiving, at a node in the communication network, a control packet;
identifying, from data in the control packet, a range of time slots to transfer a data burst associated with the control packet;
encoding the range of time slots into a search data set comprising one or more elements expressed in ternary form;
searching an addressable memory module using the one or more elements from the search data set; and
assigning one or more available time slots to a data burst associated with the control packet.

21. The method of claim 20, further comprising updating the addressable memory module to indicate time slots assigned to the data burst associated with the control packet.
